(19) United States
(12) Patent Application Publication
(10) Pub. No.: US 2014/0063176 A1
(43) Pub. Date: Mar. 6, 2014

(54) ADJUSTING VIDEO LAYOUT

(71) Applicant: AVAYA, INC., Basking Ridge, NJ (US)

(72) Inventors: Ori Modai, Ramat-Hasharon (IL); Einat Yellin, Tel Aviv (IL)

(73) Assignee: AVAYA, INC., Basking Ridge, NJ (US)

(21) Appl. No.: 14/018,270

(22) Filed: Sep. 4, 2013

Related U.S. Application Data
(60) Provisional application No. 61/697,152, filed on Sep. 5, 2012.

(51) Int. Cl. H04N 5/232

(52) U.S. Cl. CPC H04N 5/23219
USPC 348/14.05

(57) ABSTRACT

Disclosed is a system and method to present several ways to analyze one or more camera feeds captured in a room. This may include selection of different optimized feeds. This may include further optimization of feeds by changing the pan, tilt, zoom settings of the cameras. These methods and optimizations are applied to views shown to remote participants.

### FIELD OF THE INVENTION

The field of the invention relates generally to communications conferencing and video capture.

### BACKGROUND OF THE INVENTION

Videoconferencing is the conduct of a videoconference (also known as a video conference or video-teleconference) by a set of telecommunication technologies which allow two or more locations to communicate by simultaneous two-way video and audio transmissions. Videoconferencing uses audio and video telecommunications to bring people at different sites together. This can be as simple as a conversation between people in private offices (point-to-point) or involve several (multipoint) sites in large rooms at multiple locations. Besides the audio and visual transmission of meeting activities, allied videoconferencing technologies can be used to share documents and display information on whiteboards.

Simultaneous videoconferencing among three or more remote points is possible by means of a Multipoint Control Unit (MCU). This is a bridge that interconnects calls from several sources (in a similar way to the audio conference call). All parties call the MCU, or the MCU can also call the parties which are going to participate, in sequence. There are MCU bridges for IP and ISDN-based videoconferencing. There are MCUs which are pure software, and others which are a combination of hardware and software. An MCU is characterized according to the number of simultaneous calls it can handle, its ability to conduct transposing of data rates and protocols, and features such as Continuous Presence, in which multiple parties can be seen on-screen at once. MCUs can be stand-alone hardware devices, or they can be embedded into dedicated videoconferencing units.

### SUMMARY

An embodiment of the invention may therefore comprise a method for providing a context aware video presentation for a video conference room comprising one or more video cameras and a video conference system, the method comprising for each of the one or more video cameras, capturing a camera view, for each camera view, extracting one or more of a plurality of attention locations, for each camera view, extracting one or more of a plurality of attention vectors, scoring the one or more extracted attention locations, adjusting the scored one or more extracted attention locations by the extracted one or more attention vector selecting one or more of the adjusted scored one or more extracted attention locations, and optimizing the camera view at the selected one or more adjusted locations.

An embodiment of the invention may further comprise a system for providing a context aware video presentation for a video conference room, the system comprising a plurality of video cameras for providing video feeds to the video conferencing system, and a video conferencing system enabled to capture a camera view for each of said plurality of video cameras, extract a plurality of attention locations for each camera view, extract a plurality of attention vectors for each camera view, score the extracted attention locations, adjust the scored extracted attention locations by the extracted plurality of attention vectors, select at least one of the plurality of adjusted attention locations, and optimize the camera view at the adjusted attention location.

### BRIEF DESCRIPTION OF THE DRAWINGS

FIG. 1 shows a system for a video conference system.

FIG. 2 shows a flow diagram for a context aware video call.

### DETAILED DESCRIPTION OF THE EMBODIMENTS

In an embodiment of the invention, the ability to capture a video from a meeting room is provided. Generally, when a remote user joins a video conference with a meeting room system, the user may encounter a number of experiences. The current cameras used in the video conference by other users may not automatically adjust to a setting in the room to optimize according to the people in the room. The meeting room may be captured by a camera from the long end of the room, making certain portions of the room, and participants, seem disengaged due to the distance from the camera. If the camera is zoomed at one participant, the remote user may lose the context of the entirety of the room. Conversations in the room may be hard to track as the participants may not be facing the camera when speaking. The speakers may indeed face others in the room or a display intended for the conference. When the focus of attention of the participants is drawn to a point in the room, the camera is not diverted to the focus point. The camera generally has not method to know what the focus is. When multiple cameras are set in a room, a user may need to manually select which feed he wants to use for viewing. User voice tracking is one method of providing camera focus and attention functionality. Face detection hints may also be used to provide camera focus and attention functionality.

Face detection is used in biometrics, often as a part of (or together with) a facial recognition system. It is also used in video surveillance, human computer interface and image database management. Some recent digital cameras use face detection for autofocus. Face detection is also useful for selecting regions of interest in photo slideshows that use a pan-and-scale Ken Burns effect. It is understood that there are a variety of face detection algorithms available that may be used to determine a variety of characteristics regarding any number of participants in a video conference. This includes facial expressions, the direction a participant is looking, who is an active speaker and other characteristics. Algorithms may also be used to consider the layout of a room and detect changes in that layout. Utilization of face detection and other algorithms in embodiments of this invention provide new and useful methods and systems for contextual camera video control.

Accordingly, an embodiment of the invention is to present several ways to analyze one or more camera feeds captured in a room. This may include selection of different optimized feeds. This may include further optimization of feeds by changing the pan, tilt, zoom settings of the cameras. These methods and optimizations are applied to views shown to remote participants.

The present invention provides optimization of the pan-tilt-zoom (P-T-Z) setting of a camera according to the location of the participants in a room. The invention may also provide identification of the focus of the attention of participants in the room and adjustments of camera P-T-Z settings in the room. The invention may provide optimal camera selection according to the context of the meeting in the room and analysis of the camera feeds content.

Accordingly, a method and system of the invention may be provided to utilize multiple cameras placed in a meeting room and video stream image analysis to identify the context of the discussion in the meeting room. An optimized view, or views, from the room may be obtained.

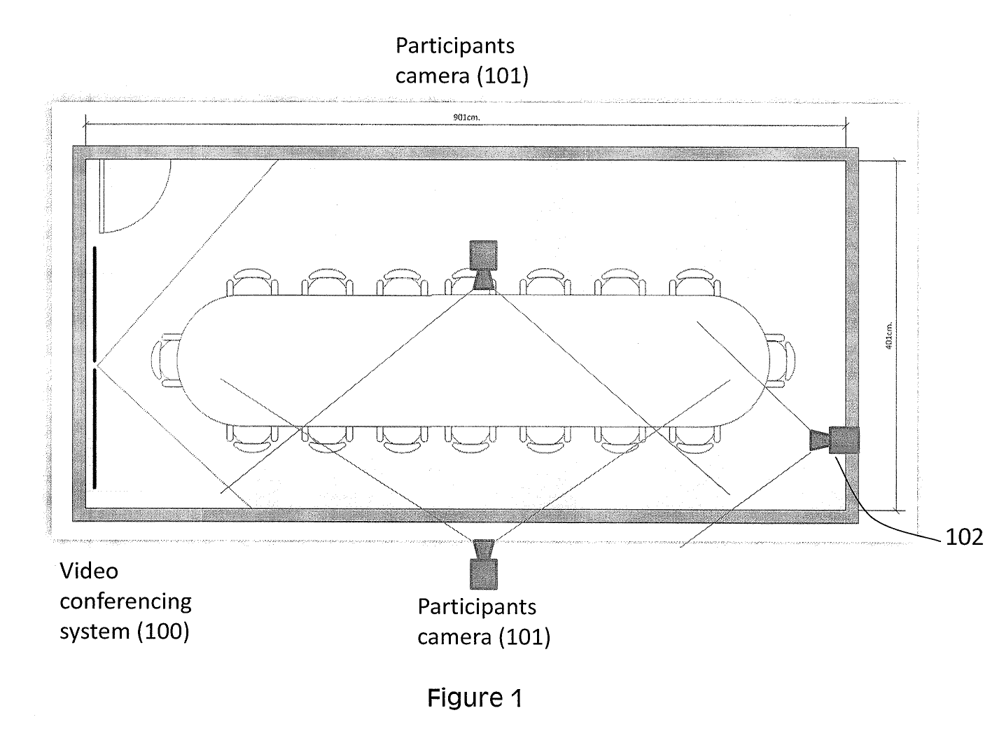

FIG. 1 shows a system for a video conference system. A system of the invention comprises a video conference system 100, with multiple feeds from different cameras positioned in different places in a room. A participant side camera 101 may be situated on either side of a conference room. A participant end camera 102 may be situated on an end of a conference room. The system may be calibrated to the structure and dimensions of the room. In the example shown in FIG. 1, the room is dimension 401 cm×802 cm. The system may be aware of the locations of each camera. This awareness may include the range of pan-tilt view, direction of a current P-T setting and relative location of other cameras.

In a system of the invention, each camera 101, 102 is enabled to have a number of capabilities. These capabilities include 1) being able to capture a wide view angle of a room from the camera's position, and 2) being able to pan-tilt and zoom on a specific segment in a room. This second capability may either be performed mechanically, digitally or both.

For each camera of a system 100, the system 100 will analyze a camera view. For each camera view, the following data is extracted as “attention location” and “attention vectors”. Attention location may comprise a location of movement in the field of view, a location of people in the field of view, a location of faces in the field of view (including emotion/engagement classification, lip movement etc.), foreground objects (this may include changes from the room normal background settings, for example identifying objects that are hiding normal room background) and predefined room location ns such as white boards, interactive boards, projector screens, audience microphones, documents camera tables and similar items. Attention vectors may comprise a direction vector for people in the camera view (this may include posture, gestures, pointing direction, and movement vector) and participant face information (this may include gaze vector, face orientation). It is understood by those skilled in the art that automatic face detection algorithms and methodologies may be used to determine attention vectors and attention location.

For both Attention location and Attention vectors, the results are evaluated. For each attention location information, the system performs scoring to determine highest score attention locations. For each attention vector, the system extrapolates the vector direction. If an attention location is within an attention vector, the score of the attention location is adjusted according to the amount of attention vector that are pointing in its direction. It is understood that any method of scoring the attention location may be used. The scoring may be based on any criteria that a user, system administrator or other determines is useful to selecting and optimizing a camera view.

After the scoring process, the system selects a camera view that contains the most attraction locations. This selected camera view is optimized. Optimizing the camera view may include adjusting the P-T-Z settings of the selected camera to optimize the composition of the scene within the camera view to contain all attraction locations in the selected camera view.

The system maintains tracking of the attention location as long as the attention score for each location is above a given threshold. Once a camera view is optimized, the system can select to switch to the optimized camera view. This method and system can be applied to all camera views in a particular room.

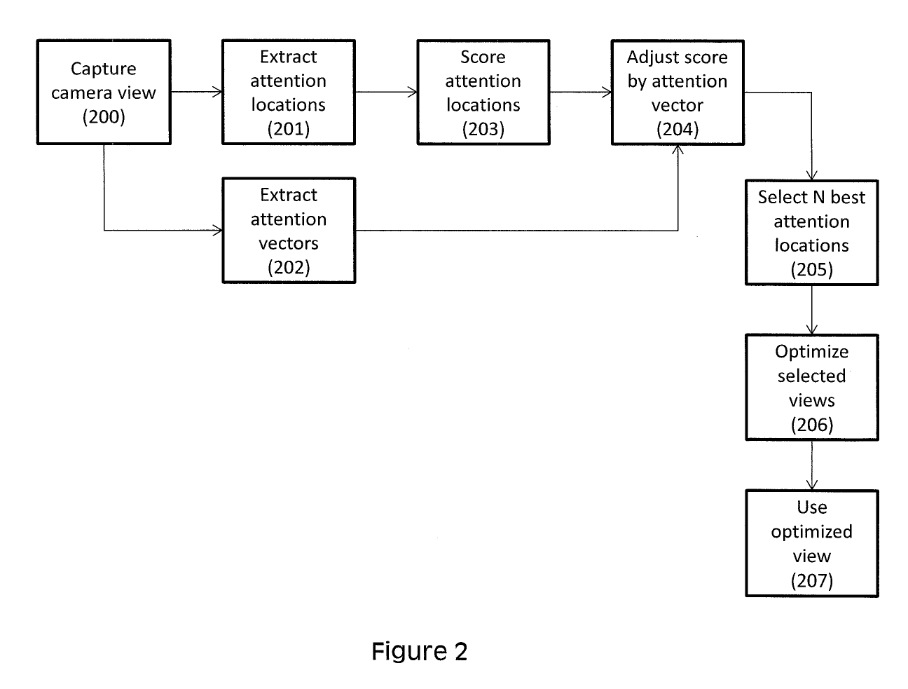

FIG. 2 shows a flow diagram for a context aware video call. In step 200 a camera view is captured. In step 201, attention locations are extracted from the camera view. In step 202, attention vectors are extracted from the camera view. In step 203, the extracted attention locations are scored as noted above. In step 204, the scored attention locations are adjusted by the attention vector. In step 205, a number, N, of best attention locations are selected. In step 206, the selected N views are optimized as noted above. In step 207, an optimized view is utilized.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for providing a context aware video presentation for a video conference room comprising one or more video cameras and a video conference system, said method comprising:
for each of said one or more video cameras, capturing a camera view;
for each camera view, extracting one or more of a plurality of attention locations;
for each camera view, extracting one or more of a plurality of attention vectors;
scoring said one or more extracted attention locations;
adjusting said scored one or more extracted attention locations by said extracted one or more attention vector;
selecting one or more of said adjusted scored one or more extracted attention locations; and
optimizing the camera view at said selected one or more adjusted locations.

2. The method of claim 1, wherein said process of extracting one or more of a plurality of attention locations and said process of extracting one or more of a plurality of attention vectors is performed at the same time.

3. The method of claim 1, wherein said plurality of attention locations comprises:
a location of movement in the camera view;
a location of conference participants in the camera view;
a location of faces in the camera view;
changes in foreground objects; and
predefined room locations.

4. The method of claim 3, wherein said changes in foreground objects comprises identifying objects that hide normal room background.

5. The method of claim 3, wherein said location of faces in the field of view comprises emotion classification, engagement classification and lip movement.

6. The method of claim 3, wherein said predefined room locations comprise locations including white boards, interactive boards, projector screens, audience microphones and document camera tables.

7. The method of claim 1, wherein said optimizing the camera view comprises adjusting P-T-Z settings of the camera at said selected locations to optimize the composition of a scene within a field of view in order to contain all attraction locations of said camera in the camera view.

8. The method of claim 3, wherein:
said changes in foreground objects comprises identifying objects that hide normal room background;
said location of faces in the camera view comprises emotion classification, engagement classification and lip movement; and
said predefined room locations comprise locations including white boards, interactive boards, projector screens, audience microphones and document camera tables.

9. The method of claim 1, wherein said attention vectors comprise one or more direction vectors for participants in the camera view and participant face information.

10. The method of claim 9, wherein said one or more direction vectors for participants in the camera view comprise posture, gestures, pointing direction and movement vectors.

11. The method of claim 9, wherein said participant face information comprises a gaze vector and face orientation.

12. A system for providing a context aware video presentation for a video conference room, said system comprising:
a plurality of video cameras for providing video feeds to the video conferencing system; and
a video conferencing system enabled to
i) capture a camera view for each of said plurality of video cameras;
ii) extract a plurality of attention locations for each camera view;
iii) extract a plurality of attention vectors for each camera view;
iv) score said extracted attention locations;
v) adjust said scored extracted attention locations by said extracted plurality of attention vectors;
vi) select at least one of said plurality of adjusted attention locations; and
vii) optimize said camera view at said adjusted attention location.

13. The system of claim 12, wherein said optimization of said camera comprises adjustment of P-T-Z settings of said selected camera to optimize the composition of a scene within a field of view in order to contain all attraction locations of said camera in the camera view.

14. The system of claim 12, wherein said attention vectors comprise one or more direction vectors for participants in said camera view and participant face information.

15. The system of claim 14, wherein said one or more direction vectors for participants in the camera view comprise posture, gestures, pointing direction and movement vectors.

16. The system of claim 12, wherein said plurality of attention locations comprises:
a location of movement in the camera view;
a location of conference participants in the camera view;
a location of faces in the camera view;
changes in foreground objects; and
predefined room locations.
